(19) United States
(12) Patent Application Publication
(10) Pub. No.: US 2025/0305855 A1
(43) Pub. Date: Oct. 2, 2025

(54) SENSOR STRUCTURE FOR BRAKE PEDAL

(71) Applicant: HL Mando Corporation, Pyeongtaek-si (KR)

(72) Inventors: JongSik SONG, Pyeongtaek-si (KR); YongKyun JUNG, Pyeongtaek-si (KR)

(73) Assignee: HL Mando Corporation, Pyeongtaek-si (KR)

(21) Appl. No.: 19/097,462

(22) Filed: Apr. 1, 2025

(30) Foreign Application Priority Data
Apr. 1, 2024 (KR) 10-2024-0044171

(51) Int. Cl. G01D 5/14; B60T 7/04; G01B 7/30

(52) U.S. Cl. CPC G01D 5/145; B60T 7/042; G01B 7/30; B60T 2220/04

(57) ABSTRACT

A sensor structure for a brake pedal is disclosed. The sensor structure includes a lever member connected to a brake pedal and configured to rotate around a rotation axis, a magnet member positioned on the rotation axis and configured to rotate around the rotation axis, a coil member arranged to be wound around the magnet member, a magnet receiving member having a magnet receiving groove for the magnet member that relatively rotates with respect to the coil member, a magnet-supporting housing member having a magnet receiving member through-hole that supports the magnet receiving member, a sensing element having a sensor that detects the rotation of the magnet member, and a sensor housing member having a sensor housing body for the sensing element, and a sensor housing body coupling part positioned on one outer side of the sensor housing body coupled to the magnet-supporting housing member.

### CROSS-REFERENCE TO RELATED APPLICATION

This application claims priority to and benefit from Korean Patent Application No. 10-2024-0044171, filed on Apr. 1, 2024, the disclosure of which is incorporated herein by reference in its entirety.

### BACKGROUND

### Technical Field

The present disclosure relates to a sensor structure for a brake pedal, and more particularly, to a sensor structure for a brake pedal for sensing the operation of a brake pedal used in a vehicle.

### Related Art

A brake system for braking is essentially installed in a vehicle, and various types of systems have been proposed to obtain more stable and effective braking power according to various operating situations of the vehicle.

In general, a conventional brake system supplies hydraulic pressure necessary for braking to a cylinder using a mechanically connected booster when a driver steps on a brake pedal.

However, recently, an electronic brake system is widely used in which when the driver steps on the brake pedal, a pedal stroke sensor or a pedal travel sensor detects the movement of the brake pedal, and based on this, the driver's braking intention is transmitted as an electrical signal, and the hydraulic pressure required for braking is supplied to the cylinder, thereby enabling precise braking force control.

The digital brake pedal sensor used in such an electronic brake system is a sensor that recognizes the operating position of the brake pedal and outputs a corresponding signal. The brake pedal sensor functions to identify the driver's braking intention and output a signal for controlling hydraulic pressure/motor for the brake of the brake system.

Such a brake pedal sensor is configured to detect a change in magnetic flux generated by a change in the position of the magnet in the sensing element and output a digital signal corresponding to the change in magnetic flux.

In this case, in the sensor for the brake pedal, in other words, the sensor structure for the brake pedal, in order for the sensing element assembly equipped with the sensing element for detecting the change in the position of the magnet to operate stably, the sensing element assembly equipped with the sensing element of the PCB structure needs to be prevented from the inflow of external moisture or foreign substances.

In addition, it is necessary to develop a sensor structure for a brake pedal with a simple manufacturing process by simplifying the assembly structure of a sensing element assembly equipped with a sensing element and a magnet-supporting housing assembly.

### SUMMARY

The present disclosure is to solve the above problems, and an object of the present disclosure is to provide a brake pedal sensor structure having a structure capable of safely protecting a sensing element assembly including an electronic element such as a sensing element for detecting the operation of a brake pedal in a brake pedal sensor structure from the inflow of external moisture and foreign substances.

Another object of the present disclosure is to simplify the manufacturing process of the sensor structure for a brake pedal and facilitate the expanded application of product design by modularizing the sensing element assembly including the sensing element for detecting the operation of the brake pedal and the housing part including the magnet of the sensor structure for a brake pedal.

The objects of the present disclosure are not limited to the above-described objects, and other objects that are not mentioned will be able to be clearly understood by those skilled in the art to which the present disclosure pertains from the following description. According to one aspect of the present disclosure, there is provided a sensor structure for a brake pedal, comprising: a lever member configured to be connected to a brake pedal, and configured to rotate around a rotation axis; a magnet member positioned on the rotation axis, and configured to rotate around the rotation axis, together with the lever member; a coil member arranged to be wound around the magnet member; a magnet receiving member comprising a magnet receiving groove in which the magnet member is positioned, wherein the magnet member is configured to relatively rotate with respect to the coil member; a magnet-supporting housing member comprising a magnet receiving member through-hole that supports the magnet receiving member, wherein the magnet receiving member is configured to rotate around the rotation axis; a sensing element comprising a sensor configured to detect the rotation of the magnet member; and a sensor housing member comprising: a sensor housing body in which the sensing element is watertightly embedded therein; and a sensor housing body coupling part positioned on one outer side of the sensor housing body, wherein the sensor housing body is coupled to the magnet-supporting housing member.

The sensor housing body may be further coupled to the sensing element in an overmolding manner.

One side of the sensing element may be connected to a terminal extending in an outward direction of the rotational axis. An integrated circuit (IC) carrier that supports the sensor and a portion of the terminal may further included in order to overmold and couple the sensing element and the portion of the terminal inside the sensor housing body.

The IC carrier comprises: an IC carrier body comprising an IC receiving hole, in which the sensing element is positioned; and a terminal receiving part positioned on a side of the IC receiving hole and configured to receive the terminal connected to the sensing element positioned in the IC receiving hole.

The IC carrier may further comprise an extension part extending laterally from a side of the IC carrier body and an IC carrier body fixing part penetrating the extension part in a vertical direction.

The terminal receiving part may comprise a terminal support groove positioned in the IC carrier body to support a portion of the terminal in an extension direction of the terminal, and a terminal through-hole positioned in the IC carrier body so that another portion of the terminal penetrates the terminal through-hole.

A terminal groove may be positioned at one end of the sensor housing body, and an outer end of the terminal may be positioned within the terminal groove.

The sensing element may be disposed on the rotation axis at a predetermined distance from the magnet member to detect the rotation of the magnet member.

The sensor housing body may comprise a magnet receiving member receiving groove configured to receive the magnet member and a portion of the magnet receiving member in which the magnet member is positioned.

The magnet receiving member may comprise a cylindrical first rotating body in which a magnet receiving hole in which the magnet is positioned is positioned at one end of the rotation axis in an extension direction of the rotation axis; a cylindrical second rotating body extending from an other end of the first rotating body toward the lever member; and a lever coupling part positioned at the end of the second rotating body and coupled to the lever member.

The magnet-supporting housing member may be provided with a coil receiving groove configured to recieve the coil member so that the coil member is positioned around the magnet member.

A position fixing projection may be formed on the other outer side of the sensor housing body, and the magnet-supporting housing member may be formed to have a position fixing groove into which the position fixing projection of the sensor housing body is fitted and coupled in a state in which the sensor housing body is coupled to the magnet-supporting housing member.

The magnet-supporting housing member may be provided with a coupling member through-hole into which a coupling member for coupling the magnet-supporting housing member to one side of the vehicle internal frame is penetrated and coupled, and the coupling member coupled to one side of the vehicle internal frame by penetrating the coupling member through-hole may be configured to press a portion of the position fixing projection in a state in which the position fixing projection is fitted and coupled into the position fixing groove.

The sensor housing body coupling part may comprise an extension part protruding from the sensor housing body in an extension direction of the rotational axis; and a locking prominence part positioned at an end of the extension part, and the magnet-supporting housing member may be comprise a locking projection coupling hole into which the locking prominence part is locked and coupled in a state in which the sensor housing body is coupled to the magnet-supporting housing member.

According to another aspect of the present disclosure, there is provided a sensor structure, comprising: a lever member configured to rotate around a rotation axis; a magnet member configured to rotate together with the lever member; a magnet receiving member comprising a magnet receiving groove in which the magnet member is positioned; a magnet-supporting housing member comprising a magnet receiving member through-hole that rotatably supports the magnet receiving member; and a sensor housing member comprising a sensor housing body in which a sensing element for detecting the rotation of the magnet member is watertightly embedded therein, wherein the sensing element is detachably coupled to the magnet-supporting housing member.

The sensor housing body may be coupled to the sensing element in an overmolding manner, and one side of the sensing element may be connected to a terminal extending in an outward direction of the rotational axis.

An integrated circuit (IC) carrier that supports the sensing element and a portion of the terminal may further be included in order to overmold and couple the sensing element and the portion of the terminal inside the sensor housing body. The sensor may be disposed at a predetermined distance from the magnet member to detect the rotation of the magnet member, and the sensor housing body may be positioned to have a magnet receiving member receiving groove for receiving the magnet member and a portion of the magnet receiving member in which the magnet member is received.

A sensor housing body coupling part positioned on one outer side of the sensor housing body may be included so as to couple the sensor housing body to the magnet-supporting housing member, wherein the sensor housing body coupling part may comprise an extension part positioned to protrude in one direction from the sensor housing body, and a locking prominence positioned at an end of the extension part, and the magnet-supporting housing member may be positioned to have a locking projection coupling hole into which the locking prominence is locked and coupled in a state in which the sensor housing body is coupled to the magnet-supporting housing member.

A position fixing projection may be formed on the other outer side of the sensor housing body, and the magnet-supporting housing member may be formed to have a position fixing groove into which the position fixing projection of the sensor housing body is fitted and coupled in a state in which the sensor housing body is coupled to the magnet-supporting housing member.

The magnet-supporting housing member may be provided with a coupling member through-hole into which a coupling member for coupling the magnet-supporting housing member to one side of the vehicle internal frame is penetrated and coupled, and the coupling member coupled to one side of the vehicle internal frame by penetrating the coupling member through-hole may be formed to press a portion of the position fixing projection in a state in which the position fixing projection is fitted and coupled into the position fixing groove.

A coil member arranged to be wound around the magnet member may be further included, and the magnet-supporting housing member may be provided with a coil receiving groove for receiving the coil member so that the coil member is positioned around the magnet member.

### BRIEF DESCRIPTION OF THE DRAWINGS

The above and other objects, features and advantages of the present disclosure will become more apparent to those of ordinary skill in the art by describing exemplary embodiments thereof in detail with reference to the accompanying drawings, in which:

FIG. 1 is a perspective view of a sensor structure for a brake pedal according to an embodiment of the present disclosure viewed from above.

FIG. 2 is a perspective view of a sensor structure for a brake pedal according to an embodiment of the present disclosure viewed from below.

FIG. 3 is an exploded perspective view of a sensor structure for a brake pedal according to an embodiment of the present disclosure.

FIG. 4 is a cross-sectional view of a sensor structure for a brake pedal according to an embodiment of the present disclosure.

FIG. 5 is a cross-sectional view illustrating components shown in a cross-sectional view of FIG. 4 by disassembling them in a vertical direction.

FIG. 6 is a cross-sectional view of a sensor housing member of a sensor structure for a brake pedal according to an embodiment of the present disclosure.

FIG. 7 is an upper perspective view of an IC carrier embedded in a sensor housing member of a sensor structure for a brake pedal according to an embodiment of the present disclosure.

FIG. 8 is a lower perspective view of an IC carrier embedded in a sensor housing member of a sensor structure for a brake pedal according to an embodiment of the present disclosure.

FIG. 9 is a perspective view illustrating a state in which a sensor housing member and a magnet-supporting housing member of a sensor structure for a brake pedal according to an embodiment of the present disclosure are separated.

FIG. 10 is a partial cross-sectional view illustrating a state in which a sensor housing member and a magnet-supporting housing member of a sensor structure for a brake pedal according to an embodiment of the present disclosure are coupled to each other.

FIG. 11 is a perspective view illustrating a state in which a coupling member for coupling a sensor housing member of a sensor structure for a brake pedal according to one embodiment of the present disclosure to a magnet-supporting housing member is separated from a coupling member through-hole.

FIG. 12 is a perspective view illustrating a state in which a coupling member for coupling a sensor housing member of a sensor structure for a brake pedal according to one embodiment of the present disclosure to a magnet-supporting housing member is coupled to a coupling member through-hole.

### DETAILED DESCRIPTION OF EXEMPLARY EMBODIMENTS

Hereinafter, embodiments of the present disclosure will be described in detail so that those skilled in the art to which the present disclosure pertains can easily carry out the embodiments. The present disclosure may be implemented in many different forms and is not limited to the embodiments described herein. In order to clearly describe the present disclosure, portions not related to the description are omitted from the accompanying drawings, and the same or similar components are denoted by the same reference numerals throughout the specification.

The words and terms used in the specification and the claims are not limitedly construed as their ordinary or dictionary meanings, and should be construed as meaning and concept consistent with the technical spirit of the present disclosure in accordance with the principle that the inventors can define terms and concepts in order to best describe their disclosure.

In the specification, it should be understood that the terms such as “comprise” or “have” are intended to specify the presence of features, numbers, steps, operations, components, parts, or combinations thereof described in the specification and do not preclude the possibility of the presence or addition of one or more other features, numbers, steps, operations, components, parts, or combinations thereof.

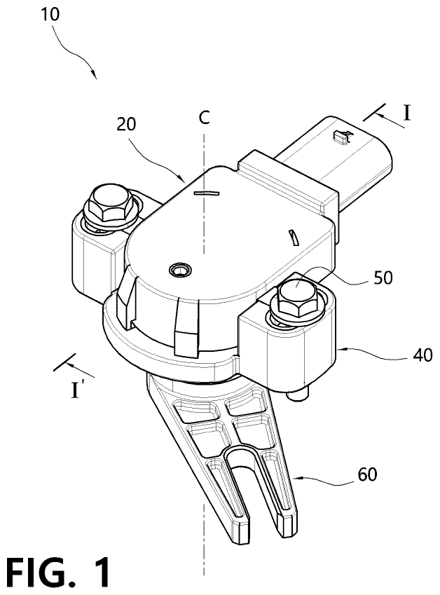

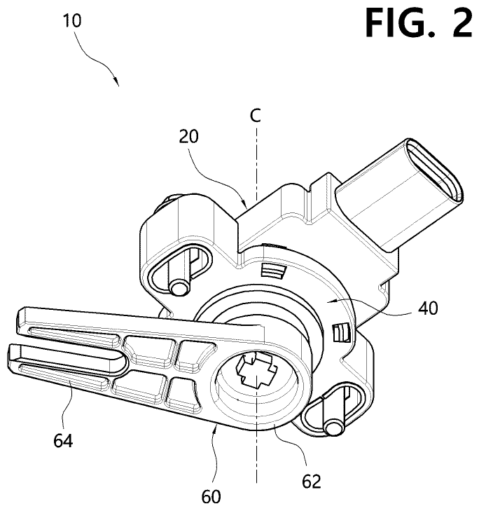

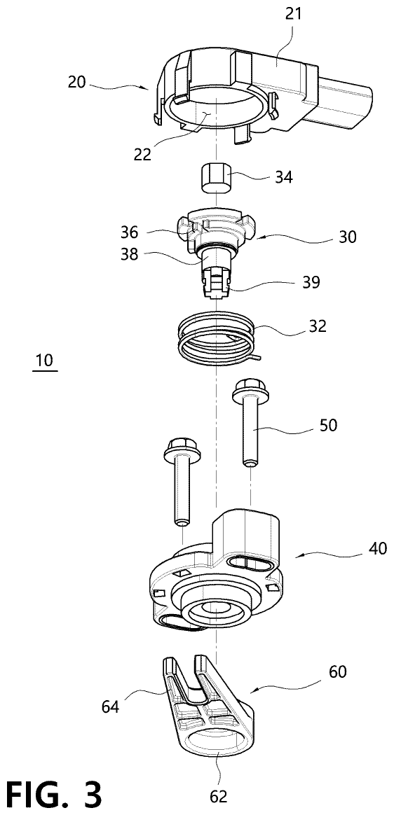

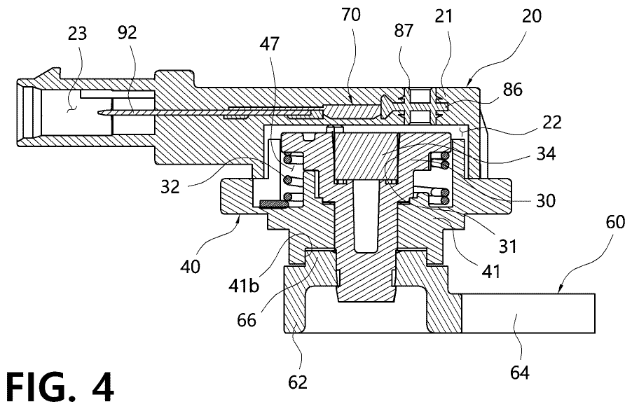

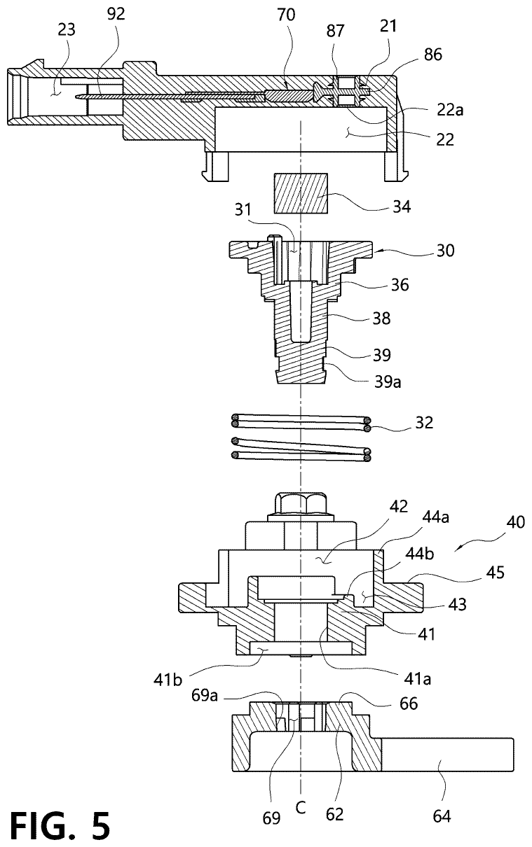

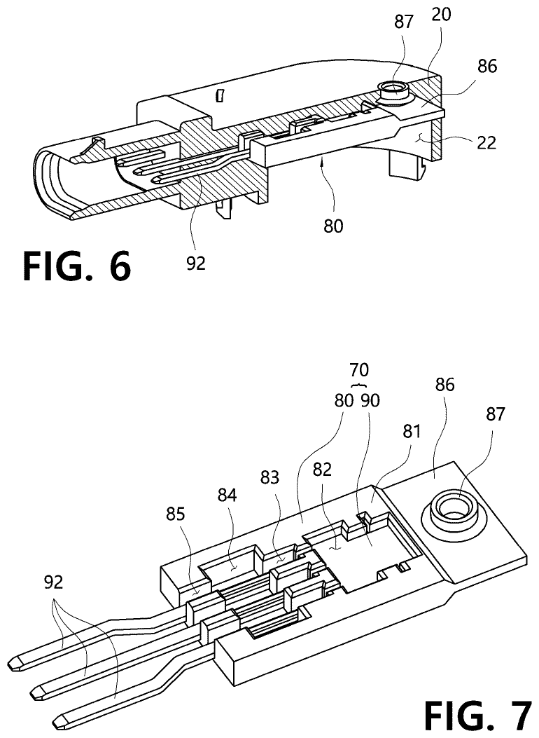

FIG. 1 is a perspective view of a sensor structure for a brake pedal according to an embodiment of the present disclosure viewed from above. FIG. 2 is a perspective view of a sensor structure for a brake pedal according to an embodiment of the present disclosure viewed from below. FIG. 3 is an exploded perspective view of a sensor structure for a brake pedal according to an embodiment of the present disclosure. FIG. 4 is a cross-sectional view of a sensor structure for a brake pedal according to an embodiment of the present disclosure. FIG. 5 is a cross-sectional view illustrating components shown in a cross-sectional view of FIG. 4 by disassembling them in a vertical direction. FIG. 6 is a cross-sectional view of a sensor housing member of a sensor structure for a brake pedal according to an embodiment of the present disclosure.

In describing the components below, when referring to FIG. 1, the direction from the sensor housing member to the lever member is defined as the downward direction, and the direction from the lever member to the sensor housing member is defined as the upward direction.

Referring to FIGS. 1 to 6, a sensor structure 10 for a brake pedal according to one embodiment of the present disclosure includes a lever member 60, a magnet member 34, a coil member 32, a magnet receiving member 30, a magnet-supporting housing member 40, a sensing element assembly 70, and a sensor housing member 20.

Referring to FIGS. 1 to 5, the lever member 60 includes a cylindrical lever body 62 that is rotatable around the a rotation axis (C), and an extension part 64 that extends from the lever body 62 in the radial direction of the rotation axis (C) and is physically connected to the brake pedal (not shown).

The lever member 60 is formed so as to be rotatable around the rotation axis (C) by the operation of the brake pedal by a vehicle driver.

A cylindrical protrusion part 66 protruding upward is formed on the upper surface of the cylindrical lever body 62 around the rotation axis (C). A through hole 69 is formed on the rotation axis at the center of the cylindrical protrusion part 66 and the lever body 62.

The projection part 69a is formed inside the through-hole 69. The projection part 69a may include an inclined surface at which the width inside the through-hole 69 becomes narrower. A projection locking groove 39a formed at a lever coupling end of the magnet receiving member 30 to be described later may be locked and coupled to the projection part 69a. However, the shape of the projection part 69a is not limited to this shape.

Meanwhile, the cylindrical protrusion part 66 is received in the protrusion part receiving groove 41b formed at the lower end of the magnet-supporting housing member 40 to be described later. Since the cylindrical protrusion part 66 is received in the protrusion part receiving groove 41b, the lever member 60 can rotate stably when the lever member 60 rotates relatively around the rotation axis (C) with respect to the magnet-supporting housing member 40.

Referring to FIGS. 1 to 5, a magnet-supporting housing member 40 is positioned above the lever body 62.

The magnet-supporting housing member 40 is a component that supports the magnet receiving member 30 so that the magnet receiving member 30 receiving the magnet member 34 can rotate together with the lever member 60.

The magnet-supporting housing member 40 includes a magnet-supporting housing member body 41 formed in a cylindrical shape. As can be seen in FIG. 5, the magnet-supporting housing member body 41 has a magnet receiving member seating groove 42, which is open in an upward direction, formed on the upper side, and a protrusion part receiving groove 41b formed on the lower side.

The magnet receiving member seating groove 42 and the protrusion part receiving groove 41b are connected to each other through a through hole 41a formed on a rotational axis in the center of the magnet-supporting housing member 40.

In one embodiment of the present disclosure, an inner protrusion wall 44b is formed in the magnet receiving member seating groove 42 in a ring shape to protrude upward from the magnet-supporting housing member body 41. In this case, a portion of the inner protrusion wall may be absent or formed with a low height in some sections when viewed in the circumferential direction. The formation of a portion of the inner protrusion wall with a low height or no height is intended to set a rotatable section of the magnet receiving member 30.

On the outer side spaced from the inner protrusion wall 44b, an outer protrusion wall 44a is formed in a ring shape to protrude upward. In this case, a portion of the outer protrusion wall may also be absent or formed with a low height in some sections when viewed in the circumferential direction. The formation of a portion of the outer protrusion wall with a low height or no height is intended to set a rotatable section of the magnet receiving member 30.

Meanwhile, the inner protrusion wall 44b and the outer protrusion wall 44a are disposed concentrically with respect to the rotation axis (C).

As can be seen in FIGS. 4 and 5, the height at which the inner protrusion wall 44b protrudes upward is formed to be lower than the height at which the outer protrusion wall 44a protrudes upward.

In addition, a coil receiving groove 43 is formed between the inner protrusion wall 44b and the outer protrusion wall 44a so that a coil member 32 can be placed.

In one embodiment of the present disclosure, the coil member 32 received in the coil receiving groove 43 is disposed around the magnet-receiving member (30), and thus, is disposed to surround the outer circumference of the magnet member 34 fixed within the magnet fixing groove 31 of the magnet receiving member 30. The coil member 32 may be, for example, a return spring, and is formed to return the brake pedal lever member 60 to the initial position in a state in which no external force is applied.

A sensor housing member seating surface 45 is formed on the outer side of the outer protrusion wall 44a of the magnet-supporting housing member body 41 around the rotation axis (C), facing upward as seen in FIG. 5.

Meanwhile, a coupling member penetration part 47 is formed on the outer side of the sensor housing member seating surface 45. A detailed description of the coupling member penetration part 47 will be described later.

Meanwhile, according to one embodiment of the present disclosure, a magnet receiving member seating groove 42 is formed on the inner side of the outer protrusion wall 44a of the magnet-supporting housing member 40. As can be seen in FIGS. 4 and 5, a magnet receiving member 30 is seated in the magnet receiving member seating groove 42.

Referring to FIG. 5, the magnet receiving member 30 includes a first rotating body 36, a second rotating body 38 formed under the first rotating body 36, and a lever coupling end 39 formed under the second rotating body 38 as viewed in the extension direction of the rotation axis (C).

The first rotating body 36 has a magnet fixing groove 31 formed on the upper end side in a cylindrical shape in the extension direction of the rotating shaft C.

The first rotating body 36 is formed so that the outer surface is stepped from the upper side to the lower side, so the upper outer surface of the first rotating body 36 is disposed to be adjacent to the outer protrusion wall 44a in a non-contact manner, and the lower outer surface of the first rotating body 36 is formed to be adjacent to the inner protrusion wall 44b.

In this case, the first rotating body 36 is formed so that it can rotate together with the magnet member 34 fixed inside the magnet fixing groove 31.

The second rotating body 38 formed under the first rotating body 36 is formed in a cylindrical shape extending downward from the lower portion of the magnet fixing groove 31, and is formed so that the outer surface is in contact with the inside of the through hole 41a of the magnet-supporting housing member body 41.

Referring to FIG. 5, a lever coupling end 39 is formed to protrude downward under the second rotating body 38.

The lever coupling end 39 penetrates the through hole 41a of the magnet-supporting housing member body 41 and protrudes downward in a state in which the magnet receiving member 30 is seated in the magnet receiving member seating groove 42, and is coupled with the lever body by penetrating the through hole 69 formed in the lever body 62.

In order to couple the lever coupling end 39 to the through hole 69 of the lever body 62, a projection locking groove 39a is formed in the lever coupling end 39.

A projection part 69a is formed on the inner surface of the through hole 69. A projection locking groove 39a may be locked and coupled to the projection part 69a.

Accordingly, the magnet receiving member 30 can rotate together with the lever member 60 in a state in which the magnet receiving member 30 is seated in the magnet receiving member seating groove 42 of the magnet-supporting housing member 40.

In this case, when the lever member 60 is rotated by an external force, the magnet member 34 fixed to the magnet receiving member 30 can rotate together with the magnet receiving member 30 when the magnet receiving member 30 rotates together with the lever member 60. In this case, the coil member 32 received inside the coil receiving groove 43 of the magnet-supporting housing member 40 may be formed to be compressed without rotating. In this case, when the external force is removed, the compressed coil member may be restored to the original position.

Meanwhile, in order to detect a change in the magnetic field according to the rotation of the magnet member 34 that can rotate inside the coil member 32, a sensor housing member 20 having a sensing element embedded therein is coupled to the upper portion of the magnet-supporting housing member 40.

Referring to FIGS. 1 to 6 and 9, the sensor housing member 20 may include a sensor housing body 21, and a sensor housing body coupling part 24 formed on an outer side of the sensor housing body to couple the sensor housing body 21 to the magnet-supporting housing member 40.

In one embodiment of the present disclosure, the sensor housing body 21 may be manufactured in an overmolding manner with the sensing element so that the sensing element can be watertight therein.

In this case, referring to FIGS. 1, 4 and 6, a receiving groove 22 opened in a downward direction is formed on the lower side of the sensor housing body 21.

As can be seen in FIG. 1, the receiving groove 22 is formed to have a cylindrical internal space so that an outer protrusion wall 44a formed on the upper side of the magnet-supporting housing member 40 and an upper side of a magnet receiving member 30 to which a magnet element 34 is fixed can be received therein.

Inside the sensor housing body 21, a sensing element assembly 70 is disposed adjacent to the downward inner surface 22a of the receiving groove 22.

In addition, referring to FIGS. 4 and 5, an external connection terminal groove 23 is formed at one end extending outward from the rotation axis (C) of the sensor housing body 21.

An end of a terminal 92 for being connected to a sensor described later and transmitting a signal sensed from the sensor to the outside is disposed inside the external connection terminal groove 23.

In one embodiment of the present disclosure, the sensing element assembly 70 includes a sensing element 90 and an IC carrier 80.

The sensing element 90 may be, for example, a structure including a circuit having a Hall sensor to detect a change in a magnetic field according to the rotation of the magnet member.

In this embodiment, the sensing element 90 may be, for example, an electronic element including a Hall sensor, a PCB substrate to which the Hall sensor is coupled, etc., i.e., a Hall IC (Hall integrated circuit). In other words, the sensing element 90 may be an integrated circuit used for contactless displacement detection, etc., and may be integrated by assembling a Hall element, an amplifier, etc., into a silicon chip.

The IC carrier 80 is a component for supporting the sensing element 90 when the sensing element 90 is manufactured by overmolding with the sensor housing body 21.

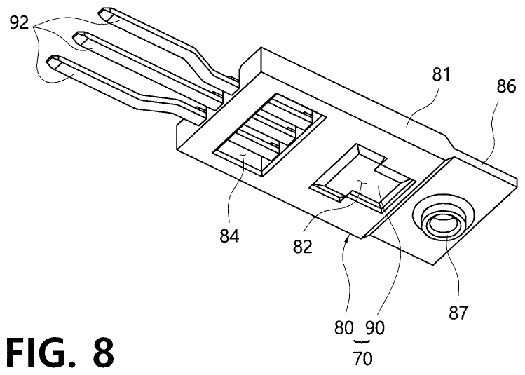

FIG. 7 is an upper perspective view of an IC carrier embedded in a sensor housing member of a sensor structure for a brake pedal according to an embodiment of the present disclosure. FIG. 8 is a lower perspective view of an IC carrier embedded in a sensor housing member of a sensor structure for a brake pedal according to an embodiment of the present disclosure.

Referring to FIGS. 6 to 8, the IC carrier 80 is formed in a hexahedral plate shape with a predetermined thickness and includes an IC carrier body 81 in which an IC receiving hole 82 is formed to penetrate in the vertical direction.

The IC receiving hole 82 can receive a sensing element 90 therein.

In this embodiment, a Hall sensor is exemplified as a sensing element embedded in the sensor housing member 20, but various types of sensors known in the art may be applied.

Meanwhile, in one embodiment of the present disclosure, the sensing element 90 is electrically connected to one or more terminals 92 extending toward the side of the IC carrier 80. In this embodiment, as shown in FIG. 8, three terminals 92 are formed to be connected to the sensing element 90 and extend to the side of the IC carrier 80. In this case, a method such as spot welding or splicing may be applied to the coupling structure of the sensing element 90 and the terminal 92.

A terminal receiving hole 84 is formed on the side of the IC receiving hole 82 inside the IC carrier 80. The terminal receiving hole 84 is formed to penetrate the vertical direction of the IC carrier 80, and is formed so that some of a plurality of terminals 92 are fixed within the terminal receiving hole 84.

A terminal connection groove 83 is formed between the terminal receiving hole 84 and the IC receiving hole 82 so that the others of the terminal 92 are fixed.

A terminal extension groove 85 is formed on the side of the terminal receiving hole 84. The terminal 92 may be formed to pass through the terminal extension groove 85 and extend in the outer direction of the IC carrier 80.

In one embodiment of the present disclosure, the sensing element 90 is formed to be connected to the terminal 92 in a state of being coupled to the IC carrier 80 and to be embedded in the sensor housing body 21 in an overmolding manner. Then, the sensor housing body 21 is coupled to the magnet-supporting housing member 40 by the sensor housing body coupling part 24.

Meanwhile, referring to FIGS. 6 to 8, an extension part 86 is extended on the side of the IC carrier body 81 in a lateral direction as viewed in FIG. 7. In addition, a cylindrical IC carrier body fixing part 87 penetrating the extension part in the vertical direction as seen in FIG. 7 is formed in the center of the extension part 86. The IC carrier body fixing part 87 is a portion that is fixed in the mold so that the IC carrier 80 is positionally fixed within the sensor housing body 21 when manufactured in an overmolding manner.

Hereinafter, a structure for coupling the sensor housing body 21 to the magnet-supporting housing member 40 will be described with reference to other drawings.

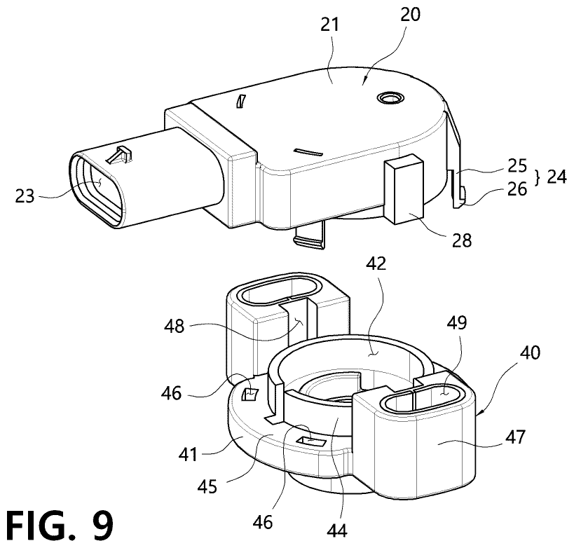

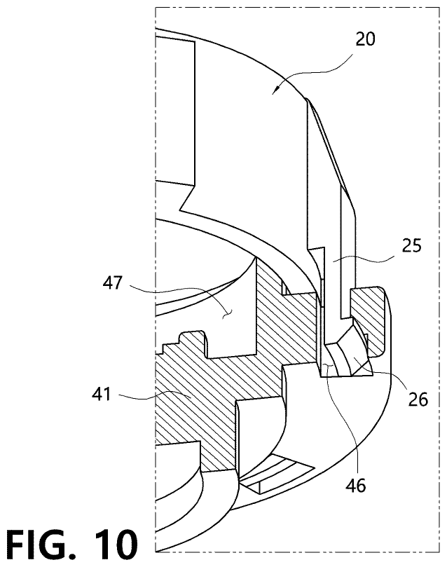

FIG. 9 is a perspective view illustrating a state in which a sensor housing member and a magnet-supporting housing member of a sensor structure for a brake pedal according to an embodiment of the present disclosure are separated. FIG. 10 is a partial cross-sectional view illustrating a state in which a sensor housing member and a magnet-supporting housing member of a sensor structure for a brake pedal according to an embodiment of the present disclosure are coupled to each other. In FIGS. 9 and 10, the magnet receiving member, magnet member, and coil member are omitted for the sake of simplicity of the drawings.

Referring to FIGS. 9 and 10, in one embodiment of the present disclosure, the sensor housing body coupling part 24 includes an extension part 25 formed to protrude from one side of the outer surface of the sensor housing body 21 in the direction of extension of the rotation axis (C), that is, in the downward direction when viewed in FIG. 9, and a locking prominence part 26 at the lower end of the extension part.

The locking prominence part 26 may be elastically locked and coupled to a locking hole 46 formed on the sensor housing member seating surface 45 of the magnet-supporting housing member body 41. In this case, as an additional modification of the present disclosure, laser welding, ultrasonic welding, hot staking, etc. may be applied to couple the sensor housing body to the magnet-supporting housing member.

In one embodiment of the present disclosure, a plurality of extension parts 25 and locking prominence parts 26 may be formed to be spaced apart from each other around the receiving groove 22 of the sensor housing body 21. A plurality of locking holes 46 corresponding to the number of locking prominence parts 26 may be formed on the sensor housing member seating surface 45.

Meanwhile, in one embodiment of the present disclosure, a position fixing projection 28 is formed on the outer surface of the sensor housing body 21. The position fixing projection 28 is for firmly fixing the sensor housing member 20 to the magnet-supporting housing member 40 in a state in which the sensor housing member 20 is coupled to the magnet-supporting housing member 40.

Referring to FIG. 9, a pair of position fixing projections 28 are formed to protrude in both lateral directions on both sides of the sensor housing body 21 in the extension direction of the terminal 92 connected to the sensing element 90, that is, in the extension direction in which the terminal groove 23 of the sensor housing member 20 is formed as seen in FIG. 9.

In this case, position fixing grooves 48 may be provided on both sides of the magnet-supporting housing member 40 so that the position fixing projections 28 protruding in both lateral directions of the sensor housing member 20 can be received.

The position fixing grooves 48 are formed on the inner surfaces facing each other of a pair of coupling member penetration parts 47 formed on both sides of the magnet-supporting housing member 40.

Accordingly, as shown in FIG. 9, when the locking prominence part 26 of the sensor housing member 20 moves downward to be fitted into the locking hole 46 of the magnet-supporting housing member (40), the position fixing projection 28 may be inserted into the position fixing groove 48 by moving from the upper side to the lower side. To this end, the position fixing groove 48 is formed to be open in the upper direction.

In addition, as shown in FIG. 10, when the locking prominence part 26 of the sensor housing member 20 is completely fitted into the locking groove 46 of the magnet-supporting housing member 40, the position fixing projection 28 is completely inserted into the position fixing groove 48.

In this case, according to one embodiment of the present disclosure, in order to more firmly maintain the state of the sensor housing member 20 coupled to the magnet-supporting housing member 40 in a state in which the position fixing projection 28 is completely inserted into the position fixing groove 48, a coupling member 50 may be formed to press the position fixing projection 28.

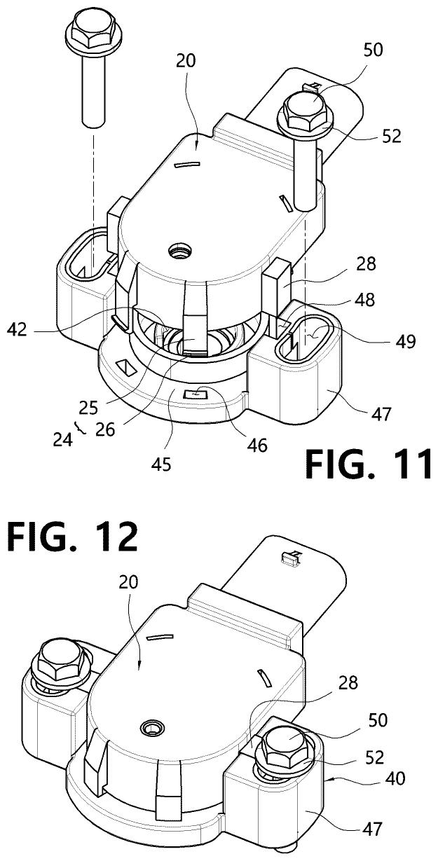

FIG. 11 is a perspective view illustrating a state in which a coupling member for coupling a sensor housing member of a sensor structure for a brake pedal according to one embodiment of the present disclosure to a magnet-supporting housing member is separated from a coupling member through-hole. FIG. 12 is a perspective view illustrating a state in which a coupling member for coupling a sensor housing member of a sensor structure for a brake pedal according to one embodiment of the present disclosure to a magnet-supporting housing member is coupled to a coupling member through-hole.

Referring to FIGS. 11 and 12, in one embodiment of the present disclosure, the coupling member 50, for example, a bolt member, may penetrate a coupling member through-hole 49 to couple a magnet-supporting housing member 40 to one side of an interior of a vehicle (not shown).

In this case, a ring-shaped washer 52 may be additionally provided at the head part of the bolt, which is the coupling member 50. In this case, when the coupling member 50 is coupled to one side of the interior structure of the vehicle, the washer 52 or one side of the head part of the bolt may press a portion of the upper end surface of the position fixing projection 28.

In this way, when the coupling member 50 fixes the magnet-supporting housing member 40 to the interior of the vehicle, the coupling member 50 or the washer 52 connected to the coupling member presses a portion of the upper end surface of the position fixing projection 28, thereby allowing the sensor housing member 20 to be more firmly fixed to the magnet-supporting housing member 40.

According to one embodiment of the present disclosure, the sensing element assembly 70 including the sensing element 90 is formed integrally with the sensor housing member 20 and modularized, thereby preventing a problem that foreign substances such as moisture flow into the sensor side of the sensing element 90 to cause malfunction or damage to the sensing element 90.

In addition, according to one embodiment of the present disclosure, the manufacturing process of the brake pedal sensor structure 10 can be simplified by modularizing and assembling the sensor housing member 20 and the magnet-supporting housing member 40.

In addition, according to one embodiment of the present disclosure, when the sensor housing member 20 is coupled to the magnet-supporting housing member 40 and then the magnet-supporting housing member 40 is fixed to the vehicle using the coupling member 50, the coupling member 50 can simultaneously pressurize the sensor housing member 20 and the magnet-supporting housing member 40 to fix them to the vehicle, so that the sensor housing member 20 and the magnet-supporting housing member 40 can be fixed to the vehicle more firmly.

According to the above configuration, the sensor structure for a brake pedal according to one embodiment of the present disclosure can operate stably by integrally manufacturing the sensing element assembly having the sensing element in an overmolding method to prevent the inflow of moisture and foreign substances from the outside.

In the sensor structure for a brake pedal according to one embodiment of the present disclosure, the sensing element assembly having the sensing element and the housing part including the magnet can be modularized and coupled, thereby simplifying the manufacturing process of the pedal structure, and facilitating assembly.

It should be understood that the effects of the present disclosure are not limited to the above-described effects, and include all effects inferable from a configuration of the invention described in detailed descriptions or claims of the present disclosure.

Although embodiments of the present disclosure have been described, the spirit of the present disclosure is not limited by the embodiments presented in the specification. Those skilled in the art who understand the spirit of the present disclosure will be able to easily suggest other embodiments by adding, changing, deleting, or adding components within the scope of the same spirit, but this will also be included within the scope of the spirit of the present disclosure.

What is claimed is:

1. A sensor structure for a brake pedal, comprising:
a lever member configured to be connected to a brake pedal, and configured to rotate around a rotation axis;
a magnet member positioned on the rotation axis, and configured to rotate around the rotation axis, together with the lever member;
a coil member arranged to be wound around the magnet member;
a magnet receiving member comprising a magnet receiving groove in which the magnet member is positioned, wherein the magnet member is configured to relatively rotate with respect to the coil member;
a magnet-supporting housing member comprising a magnet receiving member through-hole that supports the magnet receiving member, wherein the magnet receiving member is configured to rotate around the rotation axis;
a sensing element comprising a sensor configured to detect the rotation of the magnet member; and
a sensor housing member comprising: a sensor housing body in which the sensing element is watertightly embedded therein; and a sensor housing body coupling part positioned on one outer side of the sensor housing body, wherein the sensor housing body is coupled to the magnet-supporting housing member.

2. The sensor structure according to claim 1, wherein the sensor housing body is further coupled to the sensing element in an overmolding manner.

3. The sensor structure according to claim 2, wherein one side of the sensing element is connected to a terminal extending in an outward direction of the rotational axis.

4. The sensor structure according to claim 3, further comprising: an integrated circuit (IC) carrier that supports the sensor and a portion of the terminal in order to overmold and couple the sensing element and the portion of the terminal inside the sensor housing body.

5. The sensor structure according to claim 4, wherein the IC carrier comprises: an IC carrier body comprising an IC receiving hole, in which the sensing element is positioned; and a terminal receiving part positioned on a side of the IC receiving hole and configured to receive the terminal connected to the sensing element positioned in the IC receiving hole.

6. The sensor structure according to claim 5, wherein the IC carrier further comprises: an extension part extending laterally from a side of the IC carrier body; and an IC carrier body fixing part penetrating the extension part in a vertical direction.

7. The sensor structure according to claim 5, wherein the terminal receiving part comprises:
a terminal support groove positioned in the IC carrier body, and configured to support a portion of the terminal in an extension direction of the terminal, and
a terminal through-hole positioned in the IC carrier body, wherein another portion of the terminal penetrates the terminal through-hole.

8. The sensor structure according to claim 3, wherein a terminal groove is positioned at one end of the sensor housing body, and
wherein an outer end of the terminal is positioned within the terminal groove.

9. The sensor structure according to claim 2, wherein the sensing element is disposed on the rotation axis at a predetermined distance from the magnet member, and configured to detect the rotation of the magnet member.

10. The sensor structure according to claim 2, wherein the sensor housing body comprises: a magnet receiving member receiving groove configured to receive the magnet member and a portion of the magnet receiving member, in which the magnet member is positioned.

11. The sensor structure according to claim 1, wherein the magnet receiving member comprises:
a cylindrical first rotating body in which a magnet receiving hole in which the magnet is positioned is positioned at one end of the rotation axis in an extension direction of the rotation axis;
a cylindrical second rotating body extending from an other end of the first rotating body toward the lever member; and
a lever coupling part positioned at the end of the second rotating body and coupled to the lever member.

12. The sensor structure according to claim 11, the magnet-supporting housing member is provided with a coil receiving groove configured to receive the coil member, wherein the coil member is positioned around the magnet member.

13. The sensor structure according to claim 1, wherein the sensor housing body comprises a position fixing projection positioned on an other outer side of the sensor housing body, and
wherein the magnet-supporting housing member comprises: a position fixing groove into which the position fixing projection of the sensor housing body is fitted and coupled in a state in which the sensor housing body is coupled to the magnet-supporting housing member.

14. The sensor structure according to claim 13, wherein the magnet-supporting housing member is provided with a coupling member through-hole into which a coupling member for coupling the magnet-supporting housing member to one side of a vehicle internal frame is penetrated and coupled, and
wherein the coupling member coupled to one side of the vehicle internal frame by penetrating the coupling member through-hole is configured to press a portion of the position fixing projection in a state in which the position fixing projection is fitted and coupled into the position fixing groove.

15. The sensor structure according to claim 1, wherein the sensor housing body coupling part comprises: an extension part protruding from the sensor housing body in an extension direction of the rotational axis; and a locking prominence positioned at an end of the extension part, and
wherein the magnet-supporting housing member comprises a locking projection coupling hole into which the locking prominence is locked and coupled in a state in which the sensor housing body is coupled to the magnet-supporting housing member.

16. A sensor structure, comprising:
a lever member configured to rotate around a rotation axis;
a magnet member configured to rotate together with the lever member;
a magnet receiving member comprising a magnet receiving groove in which the magnet member is positioned;
a magnet-supporting housing member comprising a magnet receiving member through-hole that rotatably supports the magnet receiving member; and
a sensor housing member comprising a sensor housing body in which a sensing element for detecting the rotation of the magnet member is watertightly embedded therein, wherein the sensing element is detachably coupled to the magnet-supporting housing member.

17. The sensor structure according to claim 16, wherein the sensor housing body is coupled to the sensing element in an overmolding manner, and
wherein one side of the sensing element is connected to a terminal extending in an outward direction of the rotational axis.

18. The sensor structure according to claim 17, further comprising: an integrated circuit (IC) carrier that supports the sensing element and a portion of the terminal in order to overmold and couple the sensing element and the portion of the terminal inside the sensor housing body.

19. The sensor structure according to claim 16, wherein the sensing element is disposed at a predetermined distance from the magnet member, and configured to detect the rotation of the magnet member, and
wherein the sensor housing body is positioned to have a magnet receiving member receiving groove configured to receive the magnet member and a portion of the magnet receiving member in which the magnet member is received.

20. The sensor structure according to claim 16, further comprising: a sensor housing body coupling part positioned on one outer side of the sensor housing body and configured to couple the sensor housing body to the magnet-supporting housing member,
wherein the sensor housing body coupling part comprises an extension part positioned to protrude in one direction from the sensor housing body, and a locking prominence part positioned at an end of the extension part, and
wherein the magnet-supporting housing member is positioned to have a locking projection coupling hole into which the locking prominence part is locked and coupled in a state in which the sensor housing body is coupled to the magnet-supporting housing member.
